(19) United States
(12) Patent Application Publication
(10) Pub. No.: US 2013/0326362 A1
(43) Pub. Date: Dec. 5, 2013

(54) ELECTRONIC COMMUNICATING

(71) Applicants: Neil Hamilton Murray, Northamptonshire (GB); Craig Fullerton, Northamptonshire (GB); David Goldberg, Natick, MA (US); Simon Paul Tyler, Wiltshire (GB); Nathaniel Borenstein, Greenbush, MI (US); Peter Bauer, Southborough, MA (US)

(72) Inventors: Neil Hamilton Murray, Northamptonshire (GB); Craig Fullerton, Northamptonshire (GB); David Goldberg, Natick, MA (US); Simon Paul Tyler, Wiltshire (GB); Nathaniel Borenstein, Greenbush, MI (US); Peter Bauer, Southborough, MA (US)

(21) Appl. No.: 13/488,643

(22) Filed: Jun. 5, 2012

(51) Int. Cl. G06F 3/048

(52) U.S. Cl. 715/750; 715/752

(57) ABSTRACT

Among other things, we describe enabling two or more users to share a workspace that is dynamically populated by artifacts of electronic communications among the users that are expressed in a form of at least one of social network posts and email messages, and in which the users can interact using the artifacts in any of the forms.

### BACKGROUND

This description relates to electronic communicating. Electronic devices can be used to communicate with other users of other electronic devices using a variety of protocols.

### SUMMARY

The electronic communicating that we describe here may encompass one or more of the following (and other) aspects, features, and implementations, and combinations of them.

In general, in an aspect, a method includes enabling two or more users to share a workspace that is dynamically populated by artifacts of electronic communications among the users that are expressed in a form of at least one of social network posts and email messages, and in which the users can interact using the artifacts in any of the forms.

Implementations of this aspect may include one or more of the following features. The artifacts include at least portions of email messages that are native to an email application. The artifacts include at least portions of social network posts that are native to a social network platform. The workspace is part of a social network application or client and the workspace is part of an email client or application. Email messages are presented in a manner that enables them to be used in a social networking mode.

In general, in another aspect, a method includes associating two or more artifacts that contain content, each of the artifacts having been authored by an author in a source application that provides at least one of: (a) social network features, (b) email features, or (c) file management features, the association of the two or more artifacts being based on at least one of (a) a relationship of the authors or (b) a relationship of the content, exposing at least some of the artifacts to a user who is associated with at least one of: (a) an author of at least one of the artifacts or (b) the content of at least one of the artifacts, the artifacts being exposed through an application that provides at least one of: (a) email features, (b) social network features, or (c) file management features, at least some of the exposed artifacts having been authored natively in a source application using native features that are different from the native features that are used to expose them.

Implementations of this aspect may include one or more of the following features. One of the artifacts includes at least part of an electronic message and part of a file. At least one of the email features provided by the source application includes identifying an address of a recipient of at least one of the artifacts and one of the social network features provided by the source application comprising identifying a relationship between at least one of the users of the source application and another of the users of the source application independent of data in any electronic messages. At least one of the social network features provided by the source application includes a collaborative environment associated with a common topic. At least one of the file management features provided by the source application includes authorizing users to access the artifacts authored in the source application based on security permissions. The security permissions are associated with the artifacts or the users or both. At least one of the file management features provided by the source application includes maintaining associations between artifacts authored in the source application based on topics assigned to the artifacts and features provided by the source application comprising assigning artifacts authored in the source application to a hierarchical file system. The application exposes the artifacts through a collaborative environment associated with a common topic of the artifacts. The common topic of the artifacts is determined by the application based on content and subject field of the artifacts. The application exposes the artifacts as a collection of discrete communications, at least some of the discrete communications representing one or more of the artifacts. The application exposes the artifacts in an email user interface. A user who is associated with at least one of: (a) an author of at least one of the artifacts or (b) the content of at least one of the artifacts includes a user who has received content of at least one of the artifacts in the form of an electronic message. The association between a user and an author of at least one of the artifacts comprises a connection maintained by a social networking system. The user is associated with an organization, and the artifacts are associated based on identifying data meaningful to the organization. The user is associated with a law firm, and the artifacts are associated based on at least one of case numbers, clients, opposing parties, or opposing law firms. The user is associated with a medical provider, and the artifacts are associated based on at least one of patient identities, medical professionals, medical conditions, or medical equipment. The user is associated with an insurance firm, and the artifacts are associated based on at least one of claim numbers, policy numbers, customer identities, or employees. The user is associated with a financial firm, and the artifacts are associated based on at least one of financial instruments, customer identities, or employees. At least some of the artifacts are contributed by a user of a user interface that is native to the application.

In general, in another aspect, a method includes providing user interface representing a collaborative environment associated with a common topic selected from a collection of topics available to users of a collaborative system, receiving data from one or more users of the user interface, receiving discrete electronic messages from one or more electronic message communication systems, determining that the received data and the discrete electronic messages are related to a common topic selected from the collection of topics, and storing the received data and the discrete electronic messages in association with each other and the common topic.

Implementations of this aspect may include one or more of the following features. The method includes transmitting data to cause a computer system to present the collaborative environment. The method includes receive a data file attached to one of the received electronic messages and providing access to the data file in the collaborative environment. The method includes receiving, from a user of the user interface, a selection of the common topic from the collection of topics and displaying, in the user interface, the collaborative environment associated with the selected common topic. The method includes receiving, from a user, a selection of the common topic from the collection of topics and sending, to the user, one or more electronic messages representing portions of the collaborative environment associated with the selected common topic. The method includes receiving an authorization by a first user of the collaborative environment to allow a second user to use the collaborative environment and transmitting an invitation to the second user to use the collaborative environment. At least one electronic message conforms to Simple Mail Transfer Protocol and at least one electronic message does not conform to Simple Mail Transfer Protocol. The method includes receiving discrete electronic messages from one or more electronic message communication systems comprises receiving, from the one or more electronic message communication systems, electronic messages responsive to a query applied to the one or more electronic message communication systems. The query includes data representing the common topic. The query includes a query to a database. The query includes a call to an application programming interface. The method includes determining that a collaborative environment associated with the identified topic does not exist in the collaborative system, and generating a collaborative environment associated with the identified topic. The discrete electronic message includes an address containing data representing the identified topic and a header containing data representing the identified topic. At least some of the received data includes information about the user including geolocation data about the user from which the data was received.

In general, in another aspect, a method includes receiving data from a collaborative environment pertaining to a topic that is selected from a collection of topics and associated with a first user of the collaborative environment, the data being part of a communication composed by the first user and pertaining to the topic, and transmitting an electronic message to a second user associated with the topic, the electronic message comprising the data received from the collaborative environment.

Implementations of this aspect may include one or more of the following features. The method includes providing in the electronic message elements usable to access at least some of the functionality of the collaborative environment.

In general, in another aspect, a method includes receiving an electronic message from a first user comprising an identification of a topic and data pertaining to the topic, the topic being associated with a collaborative environment associated with the first user, the topic belonging to a set of topics supported by a collaborative system that maintains the collaborative environment and displaying to a second user through the collaborative environment, data pertaining to topic.

Implementations of this aspect may include one or more of the following features. The method includes providing, to the second user, two or more user interfaces each representing the collaborative environment, each user interface displaying the data pertaining to topic.

In general, in another aspect, a method includes receiving, from an archive of communications, data representing discrete communications, in response to an identification of a common topic among a subset of the discrete communications, generating, in a collaborative system, a collaborative environment based on the received data.

Implementations of this aspect may include one or more of the following features. The method includes providing a user interface representing the collaborative environment, the user interface presenting representations of one or more of the discrete communications of the subset. The common topic is identified based on inclusion of the discrete communications in a mailing list and a syndication feed. The common topic is identified based on data representing the common topic, the data included in the discrete communications of the subset. The data includes metadata representing the common topic. The metadata is part of the headers of at least some of the discrete communications of the subset. The common topic is identified based on data representing the common topic, the data included in a source of data other than the discrete communications of the subset.

In general, in another aspect, a system includes a topic database storing associations between users of a collaborative system and topics of the collaborative system, a user interface module to transmit data that causes a computer system to display (a) a collaborative environment pertaining to at least one of the topics of the collaborative system, and (b) content received in electronic messages containing metadata identifying at least one of the topics of the collaborative system, and an electronic messaging module configured to send electronic messages containing metadata identifying at least one of the topics of the collaborative system, at least some of the electronic messages including content received by the user interface module, and receive electronic messages containing metadata identifying at least one of the topics of the collaborative system.

In general, in another aspect, a method includes associating two or more artifacts that contain content, each of the artifacts having been authored natively by an author in a respective source application, one artifact having been authored in a first source application that provides social network features and the other artifact having been authored in a second source application different from the first source application and that provides email features, the associating of the two or more artifacts being based on at least one of (a) a relationship of the authors or (b) a relationship of the content, and in an application other than the first source application or the second source application, providing a user interface including representations of the two or more artifacts, the representations based on the associations between the artifacts.

Implementations of this aspect may include one or more of the following features. Providing a user interface including representations of the two or more artifacts includes providing a representation of a file system structure that includes representations of the two or more artifacts. Each of the two or more artifacts includes an electronic message, the content of each of the two or more artifacts includes a data file attached to the respective electronic message, and providing a user interface including representations of the two or more artifacts includes providing a user interface representing the data files.

In general, in another aspect, a system includes a communications module that receives data from a) a social networking system that provides data representative of social networking content authored natively in the social networking system and provides data files associated with at least some of the social networking content, b) an electronic messaging system that provides data representative of standalone electronic messages authored natively in the electronic messaging system and provides data files associated with at least some of the standalone electronic messages, a user interface module that enables at least some of the data received by the communications module to be viewed in the form of a) social networking content displayed in a social networking system interface, b) electronic messages displayed in an electronic message system interface, or c) data files displayed in a file system interface.

In general, in another aspect, a method includes storing at a server useful artifacts from emails and social network posts that have been authored using email platforms and social network platforms, and serving selected artifacts from emails and social network posts for presentation at the same time at each of at least two different user interfaces that have both email and social network interface features in different combinations, each user interface being displayed to a different user of the server.

In general, in another aspect, a method includes maintaining information about a body of artifacts of communications that relate to topics and have been authored by users on at least two different communication authoring platforms that have respectively different sets of authoring features including social networking and email authoring features, based on the information about the body of artifacts, serving to a client a set of the artifacts that have been authored on the two different platforms for presentation and user interaction through a single user interface chosen from among multiple user interfaces available at the client. Implementations of this aspect may include one or more of the following features. The multiple user interfaces are made available by the system that serves the set of artifacts.

In general, in another aspect, a method includes receiving and storing artifacts that can be exposed to and used by users through a variety of different interfaces at different times and at different places, the artifacts received from several different kinds of systems that are distinguished by their user interface features, each of the interfaces having any mix of interface features, including some mixes that are more similar to email interfaces, some more similar to networking interfaces, and some more similar to file system interfaces, the interfaces serving as different ways to view and interact with the different kinds of artifacts.

These and other aspects, features, and implementations, and combinations of them, may be expressed as apparatus, methods, methods of doing business, means or steps for performing functions, components, systems, program products, and in other ways.

Other aspects, features, and advantages will be apparent from the description and the claims.

### DESCRIPTION

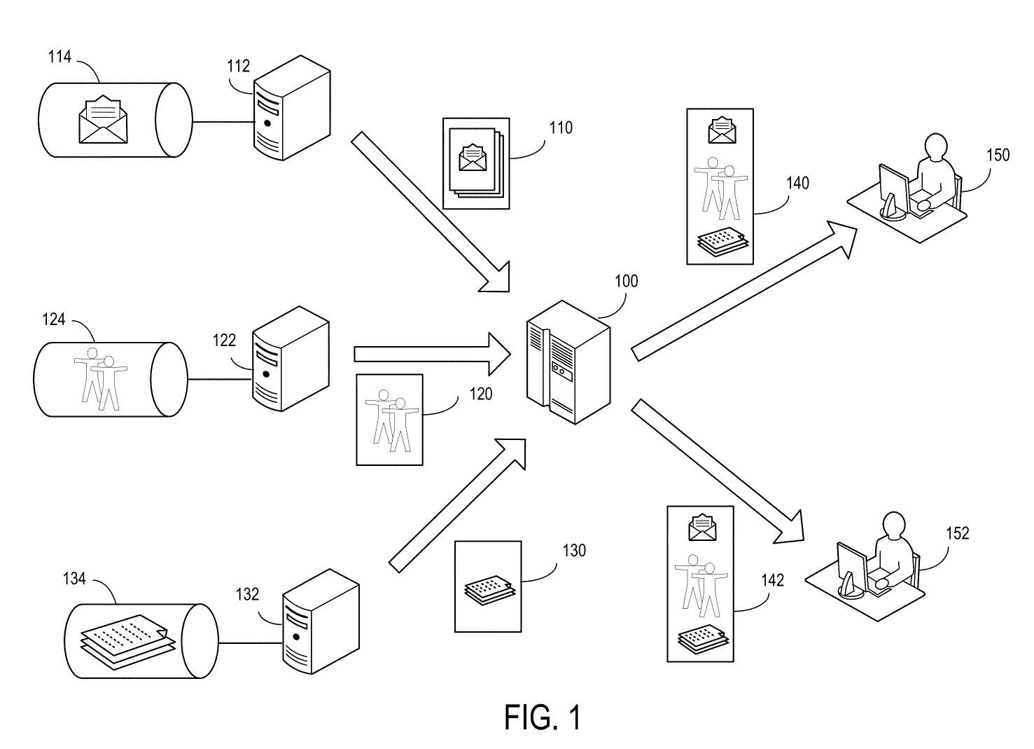

FIGS. 1 through 4 and 11 are block diagrams.

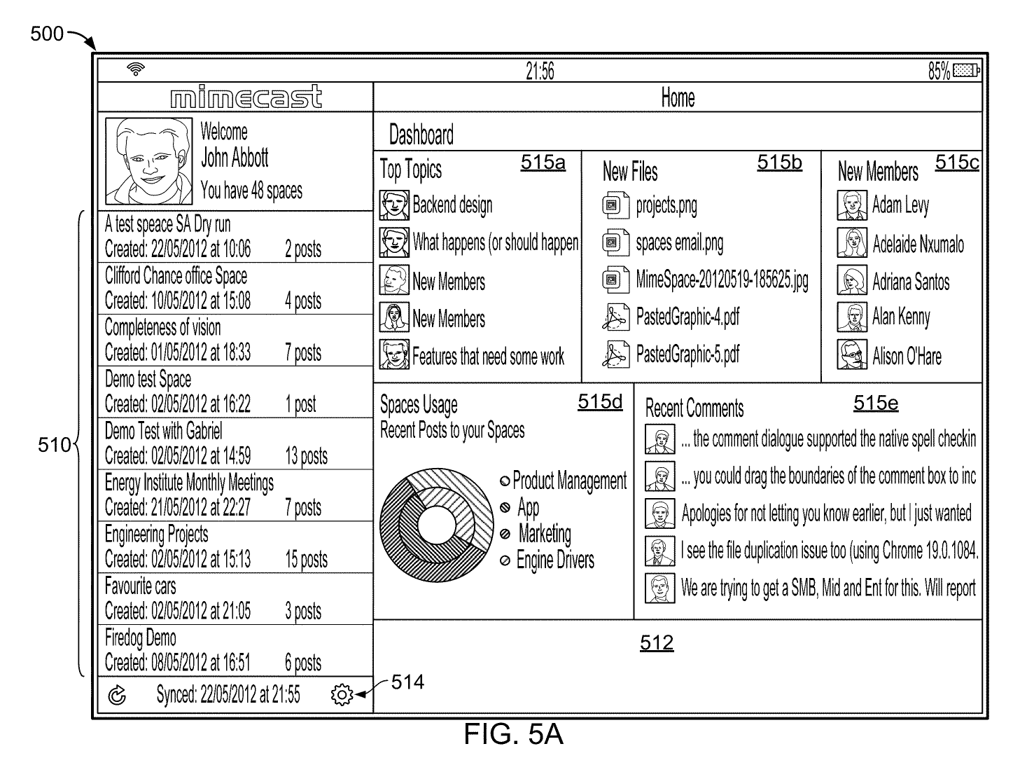

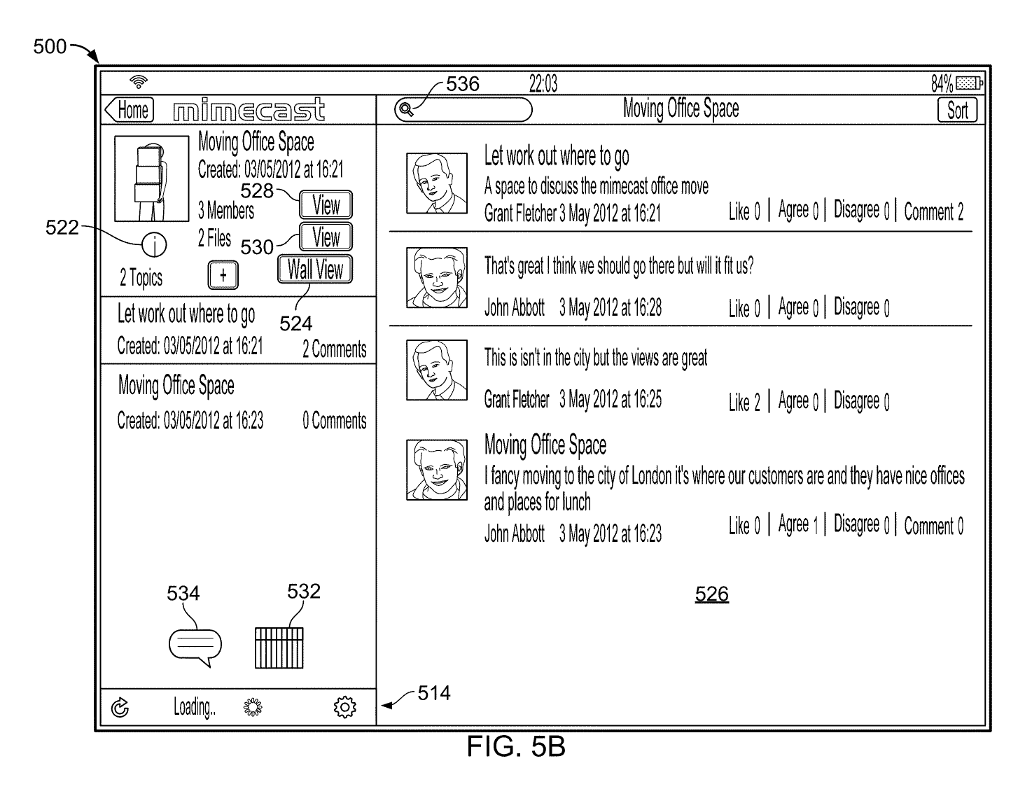

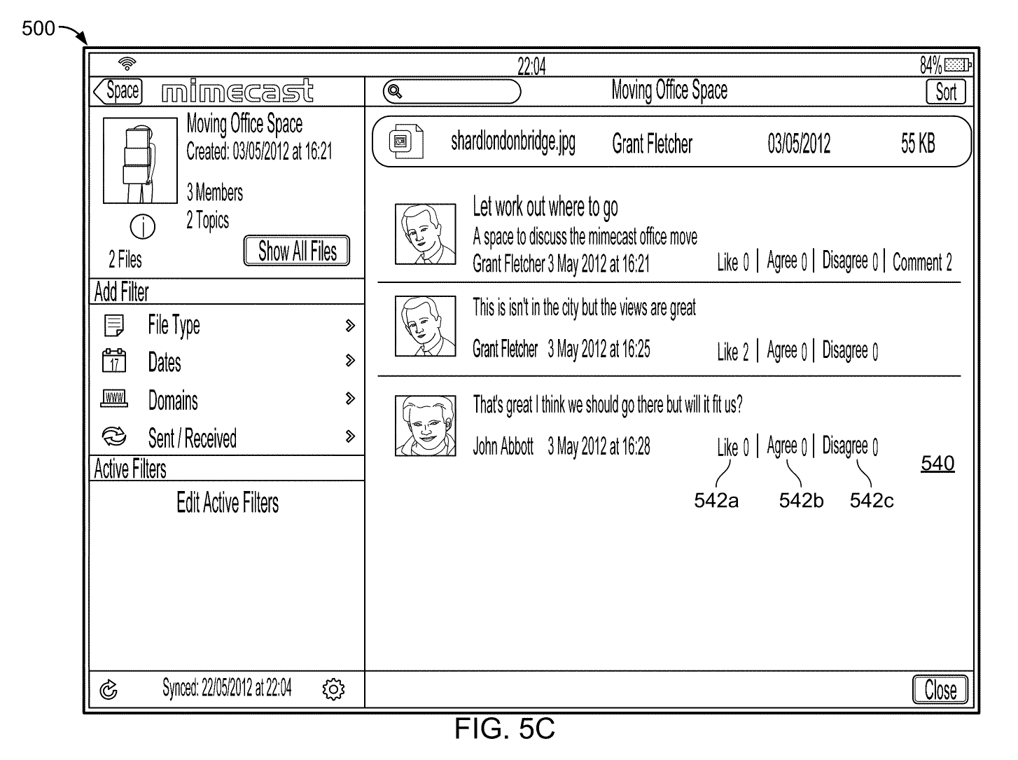

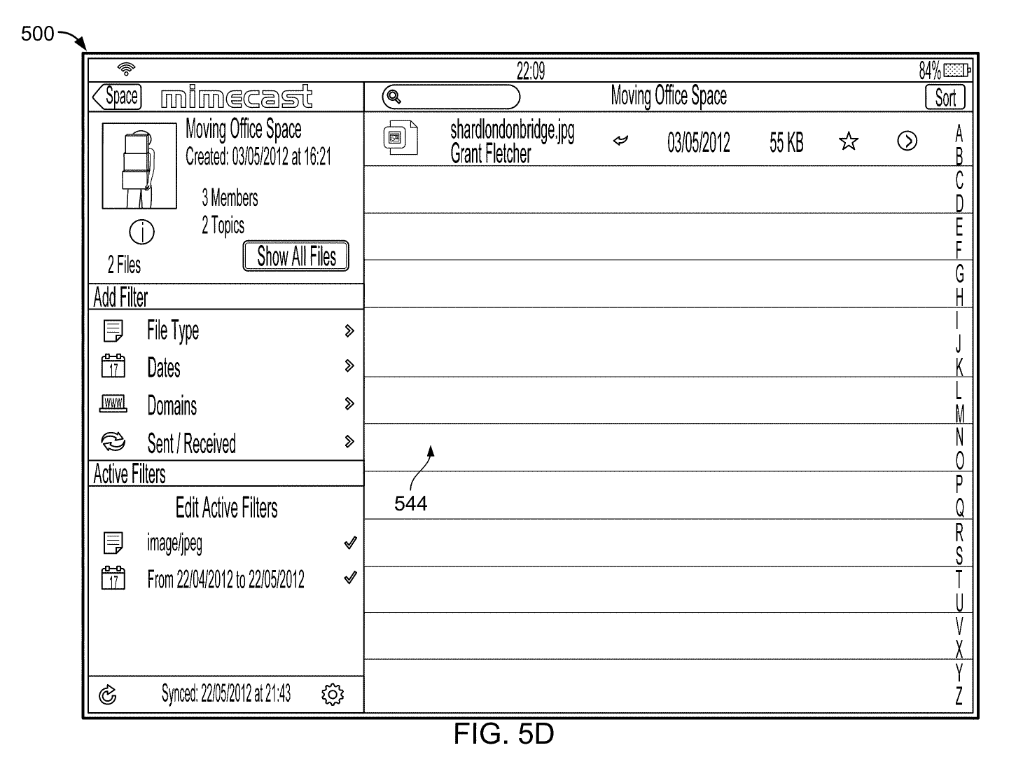

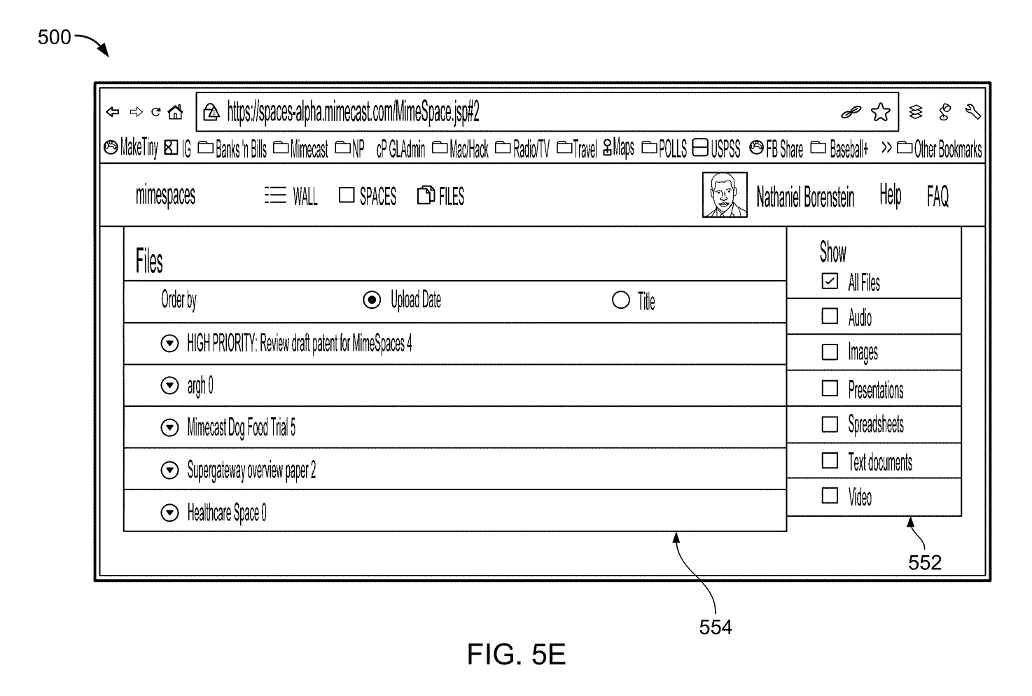

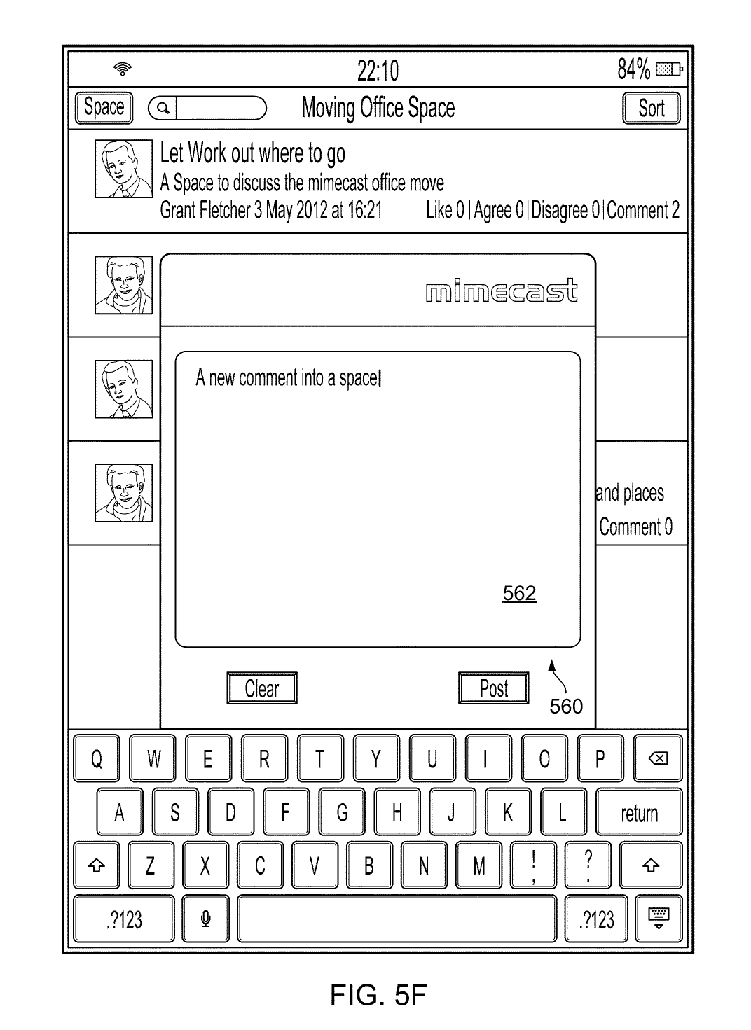

FIGS. 5 through 10 are examples of user interfaces.

Electronic communication applications enable entities to communicate using electronic facilities such as computer systems. Electronic communication applications and other electronic communicating facilities can fall under one or more of several broad categories, including email, social networking, and file management. Each of these categories is usually associated with a set of features typical of its category.

Email applications, for example, usually include functionality for sending and receiving discrete electronic messages addressed to one or more recipients. By discrete electronic messages, we mean that each message is a complete communication, and a system delivering an electronic message does not need any information derived from any other message to deliver the message. Other types of electronic messaging systems other than email systems may send and receive messages that are not discrete. Social networking applications usually include functionality for identifying relationships among users of a social networking application and relationships among communications made available to users of the social networking application. File management applications usually include functionality for creating, viewing, and editing files of one or more file types.

These categories of applications typically have underlying systems with which they allow a user to interact.

For example, an email application running on a user device allows a user to interact with an email system, which carries out the actions of sending and receiving messages sent to and from a variety of users on a variety of client computer systems (e.g., personal computers, smart phones, tablet computers, and other types of computer systems). An email system may run on a server or servers and provide the services to email applications running on clients. An email system typically operates according to standardized email protocols for sending and receiving messages. Typical email protocols include SMTP, POP3, and IMAP.

As another example, a social networking application allows a user to interact with a social networking service, which, among other things, maintains associations between users of the social networking service and content provided to the social networking service. Social networking services typically allow users to establish and maintain user profiles of information about themselves.

In some examples, social networking services identify relationships between users of the service, and the relationships are maintained independent of data in any electronic messages. The relationships are established and maintained as data by the social networking service.

A social networking service may have a particular theme. For example, some social networking services are directed to professional networking and career functions, while other social networking services are directed to sharing of personal information. A social networking service is sometimes called a social networking platform. A social networking service is sometimes maintained by a single entity such as a single service provider.

A file management application allows a user (e.g., a file system of a computer operating system, a collaborative file sharing system such as Sharepoint, or a cloud-based file sharing system such as Dropbox) to access, manipulate, and share files stored by one or more storage facilities. A storage facility could be a physical entity such as a file system on a hard drive of a computer. A storage facility could also be a distributed entity such as a “cloud”-based storage facility. A cloud-based facility can typically be accessed by many users over a network such as the Internet, and allows those used to access stored data from anywhere on the network.

In some examples, these kinds of applications are accessed using a web browser interface, a custom application interface (e.g., a dedicated email application or a file system interface of an operating system), a general use mobile application (e.g., email application), a specialized use mobile application (e.g., custom mobile application written for use with a particular system), or another kind of interface.

When we use the term artifact we mean it in a very broad sense, to include, for example, any fragment of data that forms an electronic communication. Each of these types of applications allows a user to create, send, receive, view, manage and in other respects to use artifacts. We refer to any of these types of activities and to any other use of artifacts broadly as “interacting” with or “using” artifacts. Any portion of data, such as any portion of an electronic communication, can be an artifact. Anything sent and received by a user of one of the applications can be an artifact. For example, an email message is an artifact. An email message typically has a topic (sometimes denoted by a “subject” field) and contains content written by a user about the topic. An email message can also relate to multiple topics. A portion that is less than all of an email can also be an artifact.

An email message has at least one recipient, and may have many recipients who are either individual users or groups of users (e.g., a mailing list of users). An email message could also contain multiple artifacts. For example, one portion of an email message body could be an artifact, and another portion (e.g., a portion relating to a different topic) could be a different artifact. An attachment to the email message could be yet another artifact, as could an in-line image within the email message.

As another example, a posting on a social networking service, or a portion of a posting, is an artifact. A posting on a social networking service is typically composed by a user and relates to a topic of interest by the user. The posting may be available to all other users linked to the user, or the posting may be available to only select users, or the posting may be available to all users of the social networking service, or the posting may be available to some other category or categories of users.

As another example, a portion of a real-time conversation is an artifact. For example, a real-time communication system, such as an instant messaging system that enables users to exchange short messages in real time, may be used to facilitate and record a series of messages related to a topic or multiple topics being discussed by users of the instant messaging system. The conversation may be held between two or more users; i.e., two or more users may participate in a single conversation, sometimes referred to as a single session. A transcript of messages exchanged in a single session may include one or more artifacts. Each message may be an artifact, or a portion of the conversation (e.g., a portion relevant to a particular topic) may be an artifact.

Other types of data that can be artifacts include syndication feeds (e.g., RSS feeds), voice data or other kinds of audio (e.g., recorded telephone calls, voice messages such as voicemail, transcripts of a spoken conversation, audio feeds, etc.), and video (recorded video calls, video mail or video messages, security cameras, video feeds, etc.).

Thus, an artifact typically is characterized by having utility to a user or users. A portion of data that is not useful to a user (e.g., relevant to a topic of interest to a user) may be a non-useful artifact. For example, metadata that describes technical information (e.g., file size, location on disk) about a data file or electronic message is an artifact that may be useful or not. (In some scenarios, the metadata could be considered a useful artifact if the metadata were included in a system used by a technical user such as a system administrator, and the user identified the metadata as a portion of data of interest to the user.)

One way to distinguish useful artifacts from non-useful artifacts is to identify artifacts that have content created by users. For example, an email message composed by a user is considered a useful artifact because the content within was created by the user and is therefore relevant to (i.e., has utility for; we sometimes use the terms relevance and utility interchangeably) at least the user who created it. If at least one user can be identified as a source of a portion of data then the portion of data can be inferred to be a useful artifact. Another way to identify an artifact as useful is to determine that the artifact is associated with a topic of a topic that is known or assumed to have relevance or utility to users.

For example, if some artifacts are associated with the topic “Boston,” and an electronic message appears to contain references to the city of Boston, then the electronic message or some portion of it can be inferred to be a useful artifact, one that is relevant to the topic “Boston.” Another way to identify an artifact as a useful artifact is to provide an interface through which a user can designate artifacts as useful explicitly and directly. For example, if a user provides a data file through a user interface of a system that has as a designated purpose the receiving and storing artifacts having a particular topic, then the data file can be inferred to be an artifact relevant to that topic and therefore useful. So, if the interface provides a space containing data files relevant to the topic “Boston,” and the user provides a data file to that space, then the provided data file can be inferred to be relevant to the topic “Boston,”

The categories of applications described as examples here—email applications, social networking applications, and file management applications, and other electronic communicating facilities, all provide interfaces by which useful artifacts can be created, edited, sent, received, shared, managed, and otherwise used.

Each type of application may or may not be limited in the features associated with its type. Typically, however, their features are not entirely overlapping. For example, a social networking application typically has some features that an email application does not, and vice versa. However, all of the applications that we have described (as well as other types of applications not described here) provide features that enable user interaction with and use of artifacts.

The system and techniques that we describe here can be implemented to allow a user to interact with or use artifacts that are created in different types of applications, including artifacts first created by users in email applications; artifacts first created by users in social networking applications, and artifacts first created by users in file management applications, among other kinds of applications. The system and techniques that we describe here can also be used to author artifacts, and those artifacts may be usable by an existing system such as an email system, social networking system, or file management system.

FIG. 1 is a block diagram of a system that allows users to interact with artifacts (We sometimes refer to useful artifacts simply as artifacts) first created using electronic communication applications. In the system, a communication facility 100 communicates with data storage and communication systems 112, 122, 132 to send and receive artifacts. Each of the data storage and communication systems 112, 122, 132 could be a server accessible on a network such as the Internet (e.g., by way of a local area network, a mobile telephone network, or another kind of network), or a portion of a server, or a collection of servers. The data storage and communication systems 112, 122, 132 may be accessible using applications (e.g., executable applications that provide user interfaces) running on client computer systems, workstations, mobile devices, etc. that can be used to author, interact with, and use artifacts. The communication facility 100 can then make the artifacts available for users 150, 152 to interact with (we use the term interact broadly to include any kind of use.).

The communication facility receives artifacts, such as email messages 110, social networking communications 120, and data files 130. For example, the email messages 110 can be messages authored natively using protocols of an email system 114 that operates using data storage formats and communication formats compatible with one of the data storage and communication systems 112. Some email protocols include SMTP (sometimes referred to by one of several “RFC” numbers, one of which is RFC 821), IMAP (some versions of which are RFC 3501), and POP3 (some versions of which are RFC 1081).

The social networking communications 120 can be portions of data authored natively using protocols of a social networking service 124 that operates using data storage formats and communication formats compatible with another of the data storage and communication systems 122. Some social networking services include Facebook, MySpace, Twitter, LinkedIn, and IBM SmartCloud. The references to data files 130 can be portions of data authored natively using protocols of a data management system 134 that operates using data storage formats and communication formats compatible with another of the data storage and communication systems 132. Some data management systems include cloud-based data management systems that provided distributed storage available over a network, for example, systems such as Dropbox and Box.net.

When we refer to an artifact as having been authored, we mean that at least some of the content of the artifact was created by one or more users. Typically this means that a user provided the content as input into a user interface. For example, a user may enter text using an input device or copy existing text from another source and optionally modify it. The user may input or copy other kinds of media such as images, audio, video, or any other kind of data. Sometimes, content is generated by an automated process. For example, a user may configure a device to automatically record data. To name a few examples, the device could be a video camera that automatically captures video, or a telescope that automatically captures astronomical data, a medical device that captures patient data, or geolocation data indicating a physical location of a user or a user device, or a transcription device that automatically captures spoken audio and uses speech recognition to generate text. In these examples, the content is still said to be authored by the user, even though the user did not directly input the content.

When we refer to an artifact authored natively in a particular system, we mean that the content of the artifact was generated using that system and in a manner and having a form such that the system can use the artifact in its internal processes. In some examples, an artifact authored natively in a system may have been authored by a user who performed actions in a user interface provided by or compatible with the system. In some examples, an artifact authored natively in a system may have been generated in a data format usable by the system. In some examples, the type of content contained in an artifact is determined by the system in which the artifact was authored natively. For example, artifacts authored natively in an email system may be limited to text and attachments, for example, attachments taking the form of data files or in-line data objects embedded in the message body. As another example, artifacts authored natively in a social network system may be limited to text having certain limitations, e.g., a limitation on the number of characters.

Besides content authored by a user, each of the artifacts 110, 120, 130 typically contains metadata describing the content. For example, an email message 110 may contain metadata headers that specify the email address of the author, the email addresses of the recipients, a subject line, a source email server, a destination email server (e.g., if the email message has been delivered), and other kinds of data.

A social networking communication 120 may contain metadata indicating the author of the communication, and also may contain metadata indicating, for example, security settings for the communication (e.g., who may or may not view the communication), and may contain metadata indicating user's reactions to the communication. Some social networking systems allow users to provide snap feedback a communication. In some examples, a user provides snap feedback about a communication by indicating their support for the communication, and the social networking service can attach a list of supporters to the communication. Other types of snap feedback other than support can also be used. In some examples, a user can approve of a communication, disapprove of a communication, authorized a communication, or provide another indication of the user's position with regard to the communication.

The example shown in FIG. 1 is a general example; the data storage and communication systems 112, 122, 132 could have any of several relationships to the communications facility 100. In some examples, the communications facility 100 and the data storage and communication systems 112, 122, 132 are all operated by the same entity, for example, the same service provider. In this example, the data storage and communication systems 112, 122, 132 represent systems established by the service provider to provide users with different techniques for providing artifacts 110, 120, 130 to the communications facility 100.

In some examples, at least two entities operate some subset of the communications facility 100 and the data storage and communication systems 112, 122, 132. For example, the communications facility 100 could be operated by one service provider, and the data storage and communication systems 112, 122, 132 could be each operated by a different service provider. In this example, the service provider who has established the communications facility 100 may have done so to provide a single facility with which users 150, 152 can interact with artifacts authored natively in multiple other systems.

A communications facility 100 that has received artifacts 110, 120, 130 can then provide those artifacts to users 150, 152. The artifacts can be provided by way of interfaces 140, 142 that can be used by the users 150, 152 to interact with artifacts of any type. The interfaces 140, 142 allow multiple users to work collaboratively on artifacts that share a common topic (i.e., a topic shared by each of the artifacts). For example, the communications facility 100 can accept changes to an artifact from multiple collaborating users simultaneously, and show the changes to the all of the collaborating users in real time. Collaboration need not occur in real time, however.

A user 150 can use an interface 140 to access the content of artifacts that each may have been natively authored in any type of system such as an email system 114, social networking service 124, data management system 134, or other communication system. The interface 140 may behave to some extent like one of these systems. For example, the interface 140 could have functionality similar to a social networking system, such as providing a user interface that allows a user to view information about or provided by other users of the interface. The interface 140 may also allow multiple users to interact with an artifact concurrently. For example, two users could be simultaneously collaboratively editing an artifact using versions of the same interface 140 or of different interfaces. Another interface 142 could have functionality similar to an email system, such as enabling the sending and receiving of discrete messages addressed to or composed by a user 152. The users 150, 152 can choose which kind of interface 140, 142 they wish to use, and a user can choose to use one interface 140 on one occasion and a different interface 142 on a different occasion. Any of the interfaces 140, 142 allows a user to access artifacts of any kind supported by the communications facility 100. In other words, artifacts of the body of artifacts that have been received and stored by the facility 100 can be exposed to and used by users through a variety of different interfaces at different times and at different places, and each of the interfaces may have any mix of interface features, including some mixes that are more similar to email interfaces, some more similar to networking interfaces, and some more similar to file system interfaces. In effect, the facility 100 serves as the repository of the raw material, the artifacts, from several different kinds of systems, and the interfaces serve as different ways to view and interact with the different kinds of artifacts. In some examples, the communications facility 100 could also enable users 150, 152 to use one of the systems 112, 122, 132 to access artifacts authored natively in another one of the systems 112, 122, 132. For example, if a user 150 accesses a user interface of the email system 114, the communications facility 100 can enable the user 150 to access a social networking artifact 120 using the email system 114 (and vice versa). In this way, users 150, 152 can use an existing system, for example, an existing user interface and an existing method of interaction, to interact with artifacts authored natively on other types of systems. The communications facility 100 can mediate the interaction between the users 150, 152 and the existing systems, for example, by providing data to the existing systems that is then interacted with by the users 150, 152.

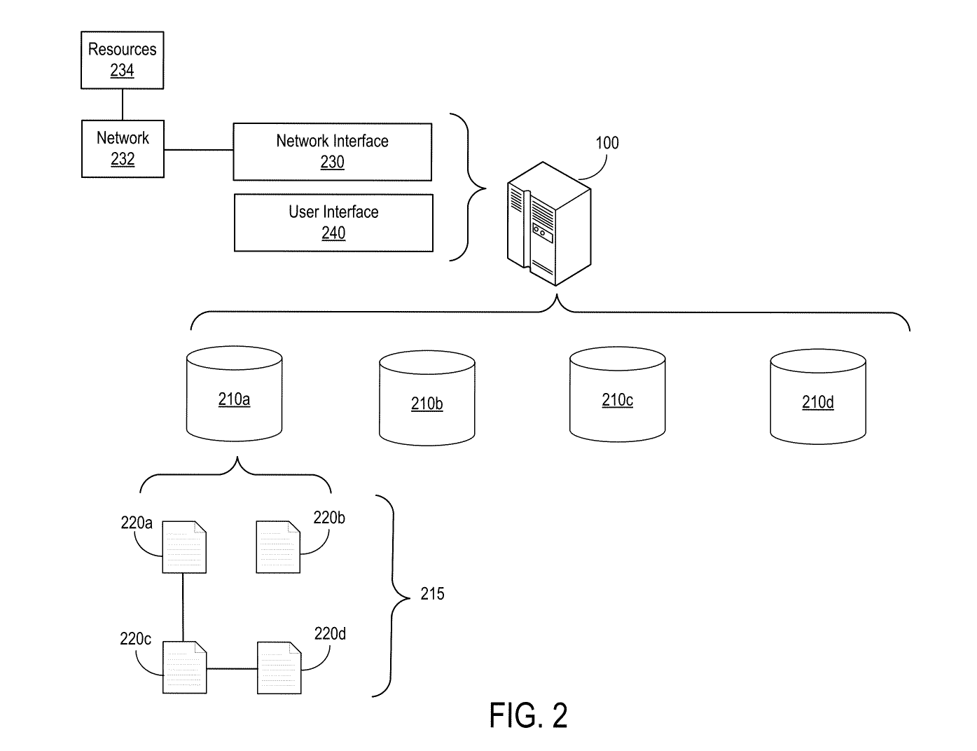

FIG. 2 shows a block diagram of an example storage technique used by the communications facility 100. In this example, the communications facility 100 assigns artifacts to one or more data spaces 210a-d. Data spaces 210a-d are defined as logically separated collections of data. A data space 210a-d need not be defined by physical constructs such as data storage devices. A data space 210a-d enables multiple users to interact with artifacts using a variety of interfaces that each provide similar features. The features can include collaborative features, for example, features that allow multiple users to interact with the same artifact. When two or more users interact with the same artifact, the artifact can be said to be shared between the two users.

When we say an artifact is assigned to or contained in a data space, we mean that the data space 210a-d stores data that references or represents the artifact. For example, a data space 210a-d may store a reference usable to access content of an artifact. The data space 210a-d itself need not store the actual content of artifacts assigned to it, although in some implementations it can store content of artifacts.

In some implementations, each data space 210a-d stores artifacts related to a common topic. For example, a data space 210a may contain artifacts 220a-d each having been identified as relevant to a topic associated with the data space 210a. In some examples, some or all of the artifacts 220a-d are identified to be relevant to a topic associated with the data space 210a based on an explicit identifier of a topic in the artifacts. For example, the artifacts 220a-d can contain a metadata field indicating a topic associated with the data space 210a. In some examples, some or all of the artifacts 220a-d are identified to be relevant to a topic associated with the data space 210a based on an analysis of the content of the artifacts. For example, the communications facility 100 can identify particular portions of text contained in the artifacts 220a-d and make inferences about the relevance of the artifacts 220a-d based on the identified text. In this way, each data space 210a-d functions as a “space” for a particular topic. Examples of data spaces 210a-d, as viewed in user interfaces, are shown in FIGS. 5 through 10.

In some examples, a data space 210a-d could be a database table, or a collection of database tables, or a portion of a database table, or another kind of data storage mechanism. In some examples, a data space 210a-d could be a file system used by a computer operating system. In some examples, a data space 210a-d may be stored on a server or collection or servers as a combination of database tables containing metadata about artifacts, including references to the artifacts stored on the server or collection or servers, or stored by another facility such as a data archive. Artifacts could be stored among many different systems and different types of systems.

In some examples, a data space 210a-d could be created by a user of the communications facility 100. In some examples, a data space 210a-d could be created by the communications facility 100, for example, automatically generated. One or more users can then add artifacts 220a-d to the data space 210a-d.

In some examples, an artifact may be contained in multiple data spaces 210a-d. For example, an artifact 220a may relate to multiple topics, and so the artifact 220a can be stored or pointed to by data spaces 210a-d each associated with one of the topics.

The communications facility 100 could be configured to identify topics of artifacts 220a-d in any of several kinds of contexts. The communications facility 100 can also automatically populate data spaces 210a-d with artifacts 220a-d based on topics identified as relevant to the artifacts 220a-d. The data spaces 210a-d can be updated to include new artifacts as new artifacts are generated or discovered, a process sometimes called dynamic population. The communications facility 100 can also automatically create a data space 210a-d based on an identification of a common topic among artifacts. One or more sources of data (e.g., an email archive) can be used to automatically create and populate a data space 210a-d.

As one example, the communications facility 100 could be used by a law firm. In this example, the communications facility could be configured to identify case numbers, clients, opposing parties, or opposing law firms in artifacts, and assign the artifacts to data spaces 210a-d based on this identification. For example, the communications facility 100 could identify a name of an opposing law firm in email artifacts, and assign all of those email artifacts to a data space 210a-d associated with a topic representing the opposing law firm. Further, if some of the email artifacts also identify the name of a case number, then those email artifacts could also be assigned to a data space 210a-d associated with a topic representing the case number. Also, the communications facility 100 can automatically create a new data space 210a-d if one does not exist. For example, the communications facility 100 may be configured to generate a new data space 210a-d whenever it encounters a case number that it has not yet encountered, or for which no data space yet exists.

As another example, the communications facility 100 could be used by an insurance firm, and the artifacts could be associated with data spaces 210a-d based on claim numbers, policy numbers, customer identities, or employee names.

As another example, the communications facility 100 could be used by a financial firm, and the artifacts could be associated with data spaces 210a-d based on financial instruments, customer identities, or employee names.

The communications facility 100 can identify a topic of an artifact in other ways. For example, the communications facility 100 may identify an author of an artifact (e.g., the sender of an email message) and use known information about the author to determine a topic. For example, a topic associated with a data space 210a-d could be a particular individual, and so artifacts authored by that individual can be assigned to that data space.

The communications facility 100 can also identify a topic of an artifact based on a source of the artifact. For example, the communications facility 100 may receive communications directed to a particular mailing list or a particular syndication feed (e.g., an RSS feed). The communications facility 100 can generate a data space 210a for a mailing list, for example, and populate the data space with email messages sent to the mailing list. Further, the communications facility 100 can add new email messages to the data space 210a when they are sent to the mailing list. The communications facility 100 could potentially subscribe to many mailing lists, syndication feeds, or other sources of content, and create data spaces for them all.

Artifacts can be arranged in a data space 210a in the form of a hierarchy 215. For example, one artifact 220c may be below another artifact 220a in the hierarchy. In turn, another artifact 220d may be below that artifact 220c in the hierarchy. In some implementations, artifacts are arranged in the hierarchy based on the date and time at which an artifact was created, or based on a priority assigned to the artifact, or based on a security level assigned to the artifact, or based on other information.

The communications facility 100 has a network interface module 230 that allows the communications facility 100 to interact with other resources 234 available on a network 232 (e.g., a local area network, a wide area network, the Internet, or another kind of network). The resources could be other communications systems such as email systems, social networking services, and data storage systems. The network interface module 230 may be a combination of software and hardware. In some examples, the network interface module 230 includes an application program interface (API) that enables the communications facility 100 to access systems such as the systems 114, 124, 134 shown in FIG. 1.

The communications facility 100 also has a user interface module 240 that enables users of the communications facility 100 to interact with the artifacts 220a-d assigned to the data spaces 210a-d. For example, the user interface module 240 may enable users to use one of the interfaces 140, 142 shown in FIG. 1. The user interface module 240 may be a combination of hardware and software.

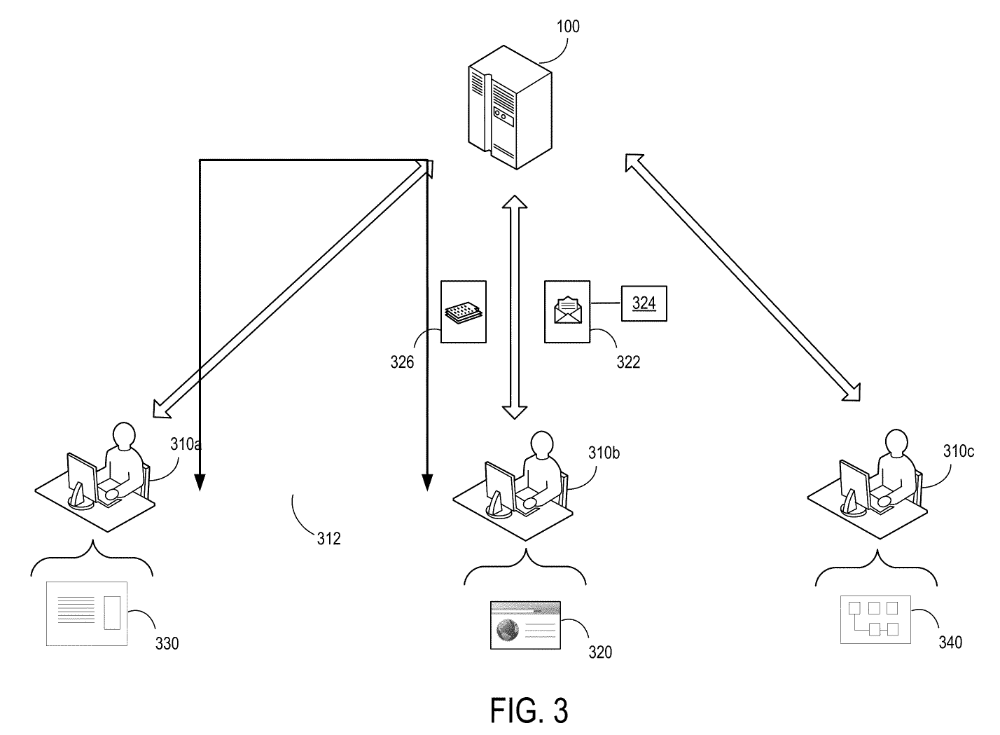

FIG. 3 shows an example use case of the communications facility 100. In the example shown, three users 310a-c (using computer systems) interact with artifacts available on the communications facility 100. For example, each of the users 310a-c accesses artifacts assigned to a data space 210a-d (FIG. 2) using different kinds of user interfaces.

One user 310a accesses artifacts using a social networking user interface 330. For example, the user 310a can view some or all of the artifacts associated with a particular topic. This user interface 330 allows the user 310a to interact with artifacts using features associated with social networking services. The features of the social networking user interface 330 may include allowing a user to view artifacts based on associations between users who authored the artifacts. For example, the user 310a may have an association 312 with another user 310b. The association can be established by one of the users 310a, 310b and stored on the communications facility 100 or stored by another social networking system (e.g., the social networking service 124 shown in FIG. 1). The social networking user interface 330 may allow the user 310a to view artifacts associated with a particular topic and authored by other users 310b with whom the user 310a has an association. In some examples, the user 310a may view all artifacts associated with a particular topic using the social networking user interface 330.

The social networking user interface 330 is a type of collaborative environment. A collaborative environment includes, for example, one that allows multiple users to use versions of the same interface to interact with artifacts and with other users, potentially in real time. Some features of the collaborative environment allow users to provide additional information about artifacts. For example, a user may be able to provide feedback about an artifact. The feedback could take the form of a comment written by a user and associated with the artifact. When the artifact is viewed by a user in the social networking user interface 330, the comment can also be displayed.

Another type of feedback could be snap feedback about an artifact. Snap feedback is an indication from a user that they approve of the content of an artifact, disapprove of an artifact, or otherwise have a opinion about the artifact. For example, if an artifact is an email message, a user could indicate in the social networking user interface 330 that the user approves (or disapproves, or has another opinion) of the email message. The social networking user interface 330 could display a note near the artifact indicating that the user approves of the email message. In some examples, the social networking user interface 330 has real-time features. For example, the social networking user interface 330 may have a real-time “chat” feature allowing real-time communication between users. (Users who are not using the social networking user interface 330 could optionally receive a transcript of chat sessions via email or another non-real-time method.) As another example, the social networking user interface 330 may allow one user to edit an artifact, and other users to see those edits in real time.

The social networking interface 330 could be displayed in a web browser, or a custom application, or another kind of system that provides user interfaces.

Another user 310b accesses artifacts using an email user interface 320. The email user interface 320 allows the user 310b to interact with artifacts using features associated with email systems. The features of the email user interface 320 may include enabling the user 310b to send and receive discrete messages which have recipients specified in each message. The messages can be formatted using a standard email message format and may be sent and received using standard email protocols. For example, the email user interface 320 may enable a user to send email messages using Simple Mail Transfer Protocol (SMTP)

The user 310b can receive email messages representing artifacts, whether or not the artifacts were originally authored in an email system. For example, each time an artifact is associated with a particular topic (e.g., each time an artifact is assigned to a data space 210a-d as shown in FIG. 2), the user 310b can receive an email message 322 representing the artifact or a portion of the artifact. An email message 322 may contain text, and an email message may also contain other kinds of media. In some examples, an email message 322 includes a file attachment 326 representing an artifact separate from an artifact represented by the body of an email message 322. A file attachment 326 could be a type of medium other than text, for example, an image or an audio file or a video file. The file attachment 326 could have any format and may or may not be displayed in-line with the message body when the email message 322 is viewed by a user. In this way, the user 310b can interact with artifacts that are not necessarily created for display in the body of an email message 322.

The user 310b can also send an email message 322 to the communications facility 100 for inclusion in a data space 210a-d (FIG. 2) as an artifact. A topic of the email address can be identified in metadata 324 contained in the email message 322. For example, the email message 322 could be sent to an email address representing a particular topic or particular data space associated with the topic. The email message 322 can be assigned to a data space based on the email address. As another example, the email message 322 could include a metadata header representing particular topic or particular data space associated with the topic. The email message 322 can be assigned to a data space based on the metadata header. The metadata header could be, for example, a custom email header, a subject field, or another kind of metadata field. In some implementations, when the user 310b replies to an email message 322 received from the communications facility, the metadata 324 is included in the reply email message by the email user interface 320. In some examples, the email user interface 320 is provided as a web interface using a web browser. In some examples, the email user interface 320 is provided as a standalone application.

Another user 310c accesses artifacts using a file system interface 340. The user 310c can use the file system interface 340 to interact with all of the artifacts associated with a particular topic (e.g., artifacts assigned to a particular data space 210a-d as shown in FIG. 2) as if the artifacts were data files in a file system. The user interface 340 allows the user 310c to interact with artifacts using features associated with file systems. For example, the user 310c may use the user interface 340 to add artifacts, create artifacts, delete artifacts, view artifacts, edit artifacts, and organize artifacts in a hierarchy, e.g., a directory structure. In some implementations, the artifacts are presented in the file system interface 340 as files contained in directories such as file folders. The file system interface 340 may allow the user 310c to view, edit, and delete metadata associated with each artifact.

The file system interface 340 could be displayed in a web browser, or a custom application, or another kind of system that provides user interfaces. In some implementations, the file system interface 340 could be an operating system interface for browsing files, such as Windows Explorer or Mac OS Finder.

As described in FIG. 2 above, a data space 210a-d can be assigned artifacts that relate to a topic associated with the data space. A data space 210a-d can also be associated with other kinds of information that is used when the artifacts are provided to users, for example, provided in one of the user interfaces 320, 330, 340.

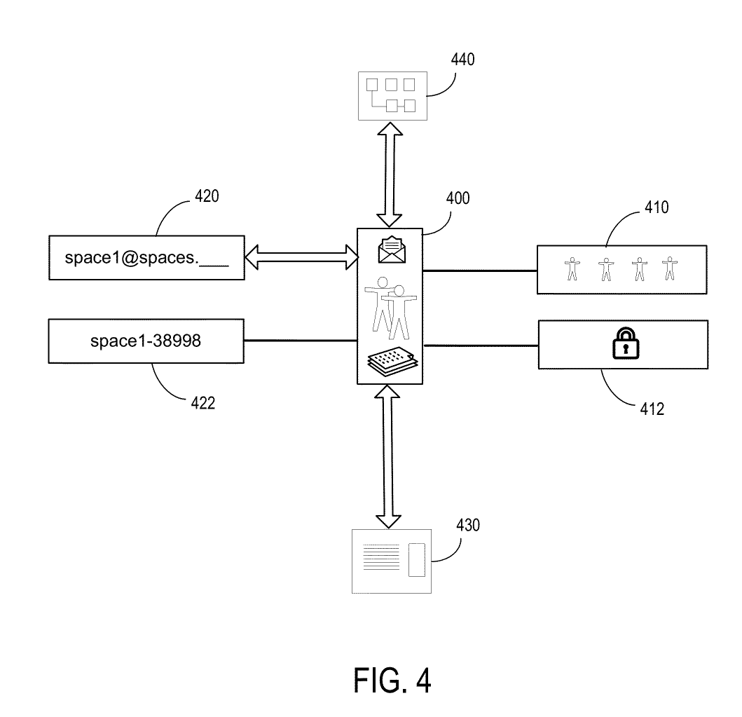

FIG. 4 shows a block diagram of a data space 400 and information that may be associated with the data space 400. The information that may be associated with the data space 400 can be thought of as metadata that describes the artifacts assigned to the data space 400 and describes associations between the artifacts and between users of the data space 400. In some implementations, the information that may be associated with the data space 400 is stored by the data space 400, e.g., in a database table. One type of information associated with the data space 400 is a list of users 410 who may access the data space 400. In some implementations, the users 410 are users of the communications facility 100. For example, the users 410 may have user accounts on the communications facility 100 which include information about the users and allow the users to access resources of the communications facility 100 when the users present credentials (e.g., a username and password). The list of users 410 may include associations between users (e.g., the association 312 shown in FIG. 3) and associations between users and artifacts. Each artifact may have an “owner,” which is a user who authored the artifact or controls the artifact or both. The owner of an artifact may have special privileges, for example, the ability to edit or delete the artifact, or enable other users to interact with the artifact. The list of users 410 may be made available by a file management interface in the form of one or more data files (e.g., a directory of data files) that can be accessed by users of the data space 400. In some examples, the list of users 410 includes other information, such as automatically collected or automatically generated information. For example, the list of users 410 can include geolocation data for some or all of the users, such that consenting participants could automatically have the system log their location as they participate in the data space 400. The list of users 410 could include other kinds of automatically collected data, for example, current sales data for a competitive sales team in a data space used by the sales team, or current rankings for players of a chess group in a data space used by the chess group.

When social networking features of the communications facility 100 are used, the associations between the users can be used to determine which artifacts may be accessed by which users. For example, the list of users 410 can be associated with security settings 412 which indicate which users may access which artifacts. For example, some security settings 412 may indicate that artifacts owned by a particular user may only be accessed by other users who have an association with that user. Some security settings 412 may indicate that artifacts owned by a different particular user may be accessed by anybody. Some security settings 412 may indicate that artifacts may be edited or deleted by some particular users 410, but other users may view the artifacts. The security settings 412 could specify any information about which users may interact with which artifacts and what actions those users may perform on the artifacts.

In some implementations, users can determine which users may access the data space 400. For example, one user on the list of users 410 can indicate that another user should be added to the list of users 410. In some implementations, the communications facility 100 can transmit an invitation (e.g., an email invitation, or a social networking communication) to the user who should be added to the list of users 410. In some implementations, the list of users 410 includes a designation of some users as moderators or administrators, who can manage settings of the data space 400, including which users may be invited to use the data space 400.

In some examples, users can be added to the list of users 410 automatically. For example, the communications facility 100 may determine that artifacts authored by a particular user are frequently added to a data space 400, and in response add that particular user to the list of users 410 for the data space 400. Other ways of identifying users to be automatically added to the list of users 410 can be used. In some examples, the identified users are not automatically added to the list of users 410, but instead suggested to a user who is ad administrator of the data space 400.

In some examples, the list of users 410 can include communication preferences of the users. For example, users can indicate a preferred email address for communication, and an indication of whether they wish to be notified when new artifacts are added to the data space 400, or when new user comments are contributed to the data space 400, when new users are added to the data space 400, and how often notifications should be provided (e.g., as events occur, or daily, or weekly, or on another schedule).

Another type of information associated with the data space 400 is an email address 420 that can be used to interact with artifacts assigned to the data space 400. In some implementations, when a user (e.g., one of the users on the list of users 410) chooses to interact with the communications facility 100 using email, and wishes to contribute an artifact to the data space 400, the user could send an email to the email address 420. The email would be received by the communications facility 100 (e.g., using the network interface module 230 shown in FIG. 2) and assigned to the data space 400. An email sent to the email address 420 could also specify other actions, such as requesting information from the data space 400. For example, a user could send an email to the email address 420 to request information about an artifact or artifacts assigned to the data space 400. In some implementations, the email address 420 could contain a command to be executed by the communications facility 100. For example, an email address of “space1+directory@spaces._” could return a directory listing of artifacts associated with the data space 400. In this way, the communications facility 100 can enable a user to interact with any of the artifacts and any of the functionality of the data space 400 using an email-based interface.

Another type of information associated with the data space 400 is a unique metadata tag 422 that identifies the data space 400. Any artifact generated by or received by the communications facility 100 can be assigned to a data space 400 based on the presence of the metadata tag 422 in the artifact. For example, an email message received by the communications facility 100 could contain the metadata tag 422 in a metadata header or as all or part of a “Subject” field (or other field) of the email message. The communications facility 100 can then assign the email to the data space 400 based on the presence of the metadata tag 422. As another example, a portion of social networking content received by the communications facility 100 could contain the metadata tag 422, or a data file received by the communications facility 100 could contain the metadata tag 422. In some implementations, the metadata tag 422 could be included in content of an artifact, for example, as a “hashtag” used in social networking content (e.g., appending “#space1-38998” to a social networking posting on a social networking system).

Another type of information associated with the data space 400 is a social networking interface format 430. The social networking interface format 430 could specify the way in which the social networking user interface 330 (FIG. 3) is displayed when a user accesses the data space 400 using the social networking user interface. For example, the social networking interface format 430 could specify a particular arrangement of content (such as the content of the artifacts) and user controls presented to a user. In this way, the social networking user interface 330 can be customized based on which data space 400 is being accessed. Multiple users accessing the data space 400 can do so using interfaces that are arranged in a similar way. In some implementations, users can customize the interface for their individual preferences.

Another type of information associated with the data space 400 is the file system organization 440 of the artifacts. As described above with respect to FIG. 2, artifacts 220a-d can be arranged in a hierarchy 215. For example, an artifact that is a communication in reply to another artifact can be placed below the other artifact in the hierarchy.

As an example use case, a user could create a data space 400 having the topic “new product idea.” The user is an employee of a company and has an idea for a new product. The user can then populate the space with email messages by sending some saved email messages about the new product idea to the email address 420 for the new data space 400. The user is, by default, the administrator of the data space, and so he can invite other users to the space by identifying each of them. The new users then automatically receive an invitation to join the space. Once they join, they can choose to receive information by email, or use a social networking interface, or both. At this time, they can indicate their settings and preferences. The user who is the administrator can set security settings for these new users, and also establish social networking connections to them, if they are not already established.

Some of the users can access the social networking interface and immediately see all of the emails in the form of artifacts. They can then add their own commentary, edit the content, provide snap feedback to indicate which emails they like the content of (or indicate other simple opinions about the content of the emails), and engage in other collaborative activities. They can also contribute their own artifacts by sending emails using an email interface or adding content in the social networking interface. As the users have conversations using email and using the social networking interface, the communications facility 100 automatically organizes the communications in the underlying file system 440. Some of the email messages include data files as attachments, which are automatically placed in the file system 440 as artifacts independent of their original email messages. Each attachment may be placed under their respective email messages in the hierarchy. Users who need to access the attachments that have been passed around among the users can use search features of the data space to bring up all of the previously sent attachments responsive to their searches. Some of the users can access the file system 440 directly to manipulate the artifacts or to see a list of the files in the data space 400.

Some of the users use a personal computer to access the data space 400, and some use a smart phone, and some use a tablet computer, and some use a variety of devices. One user prefers the social networking interface when he is at his personal computer, but when he travels, prefers to receive new artifacts via email using web email clients that he uses on other computers around the world. When he returns home, he goes back to using the social networking interface.

At a point in time, one of the users suggests a name for the new product idea, called “Amazing Widget.” The administrator then changes the topic of the data space 400 to “Amazing Widget.” As development continues and the product is produced, the communications facility 100 can search existing stores of information (e.g., email databases, file storage systems, and the Internet) for mentions of “Amazing Widget.” The communications facility 100 then populates the data space 400 with artifacts that it discovers.

The following examples show a few types of user interfaces that could be used to access resources of the communications facility 100 (FIG. 1). These are only examples showing some types of interfaces and some ways of interacting with data spaces 210a-d (FIG. 2). Many other types of user interfaces can be used, each of which can have features not discussed here.

FIG. 5A shows an example user interface 500 for accessing resources of the communications facility 100. In this user interface 500, which runs on a tablet computer, a user can select from multiple data spaces 510. The chosen data space 512 is then displayed in the user interface 500. A user of the user interface 500 also has the option of creating a new data space or performing other actions using a gear button 514. The data space 512 includes top topics 515a, new files 515b added to the data space, new users 515c added to the data space, usage data 515d, and recent comments 515e.

FIG. 5B shows another view of the user interface 500. The user interface 500 displays buttons that can be used to interact with the user interface 500. An activity button 522 causes the user interface 500 to display recent activity that has occurred in the data space, for example, artifacts recently added, users recently added, social networking activity, and other activity. A messages button 524 causes the user interface 500 to display communications from other users of the data space. The view 526 invoked by the messages button 524 is shown in the figure. The communications displayed can also include activities of the users of the data space, e.g., files added to the data space, an indication of which users have joined the data space, and other activities other than messages written by users. A members button 528 causes the user interface 500 to display a list of the users who have access to the data space. A files button 530 causes the user interface 500 to display a list of artifacts that are data files, for example, data files provided by way of email attachment or provided by way of a file system interface. A calendar button 532 causes the user interface 500 to display events pertaining to the data space, for example, artifacts that represent events such as meetings to which the users have been invited. A chat button 534 causes the user interface 500 to display an interface in which users can communicate in real time using short messages. Short messages used in real-time communication are sometimes called “instant messages.” The short messages may have a character limit, e.g., 100 characters or 150 characters, but in some examples, short messages do not have a limit. A search button 536 causes the user interface 500 to display an interface in which a user can search for strings of text or other content contained within artifacts. A gear button 514 causes the user interface 500 to display an interface in which a user can change his personal preferences, or, if applicable, security settings for himself or for artifacts he controls.

FIG. 5C shows another view of the user interface 500. In this view, a user has invoked one of the messages shown in the view 526 shown in FIG. 5B, and a threaded view 540 is displayed. Messages like these may have been created in any user interface, for example, an email user interface, or a social networking user interface. The threaded view 540 shows a conversation in which users submit replies to messages and other users can submit subsequent replies to those replies. Each reply is a discrete communication (i.e., stands alone as a discrete unit of communication). Each reply can be stored as an artifact assigned to the data space. Each message has snap feedback buttons 542a-c that allow a user of the user interface 500 to indicate an opinion about the message.

In some implementations, when a thread of messages is displayed, each message can be associated with data describing the thread. For example, each message can have a metadata field (e.g., not displayed to users) identifying the thread. The thread could be identified by identifying the first message of the thread (i.e., the message to which all subsequent messages were in reply to). In some examples, if the messages are email messages, the metadata field could be a standard or non-standard email header, such as “In-Reply-To” or “MessageID.” The metadata field could be compressed or encrypted.

The metadata field could be used for other purposes. For example, if a message contains a command, the metadata field could contain information about the command, e.g., for security reasons. If the command is related to adding a user to a data space, the metadata field could contain data describing the user being added (e.g., an email address of the user), and the data could be encrypted. Each data space could have its own encryption key, so that data or commands intended for one space cannot be decrypted by entities associated with a different data space.

In use, when a user accesses a view displaying messages, such as the threaded view 540, the user interface 500 may query a database running on the communications facility 100 (FIG. 1). For example, the query may request messages related to a topic associated with a data space. In response, the communications facility 100 transmits messages responsive to the query for viewing in the user interface 500.

FIG. 5D shows another view of the user interface 500. In this view, a user has invoked the files button 530 shown in FIG. 5B, and a list of files 544 assigned to this data space is displayed. The list of files 544 may have been email attachments contained in emails sent to the communications facility 100 for inclusion in the data space.

FIG. 5E shows another view of the user interface 500. In this view, the user interface 500 includes search options 552 that allow a user to specify characteristics of files that the user wishes to view. The user interface 500 displays a list of files 554 responsive to the search options 552.

FIG. 5F shows another user interface 560 for accessing resources of the communications facility 100. The user interface 560 is a commenting interface that allows a user to enter a comment 562 about an artifact with which the user is interacting. The comment 562 can be associated with the artifact (e.g., referenced by metadata associated with the artifact) and displayed with the artifact in other user interfaces (e.g., the user interface 500 shown in FIGS. 5A-5E). The comment 562 itself is also an artifact.

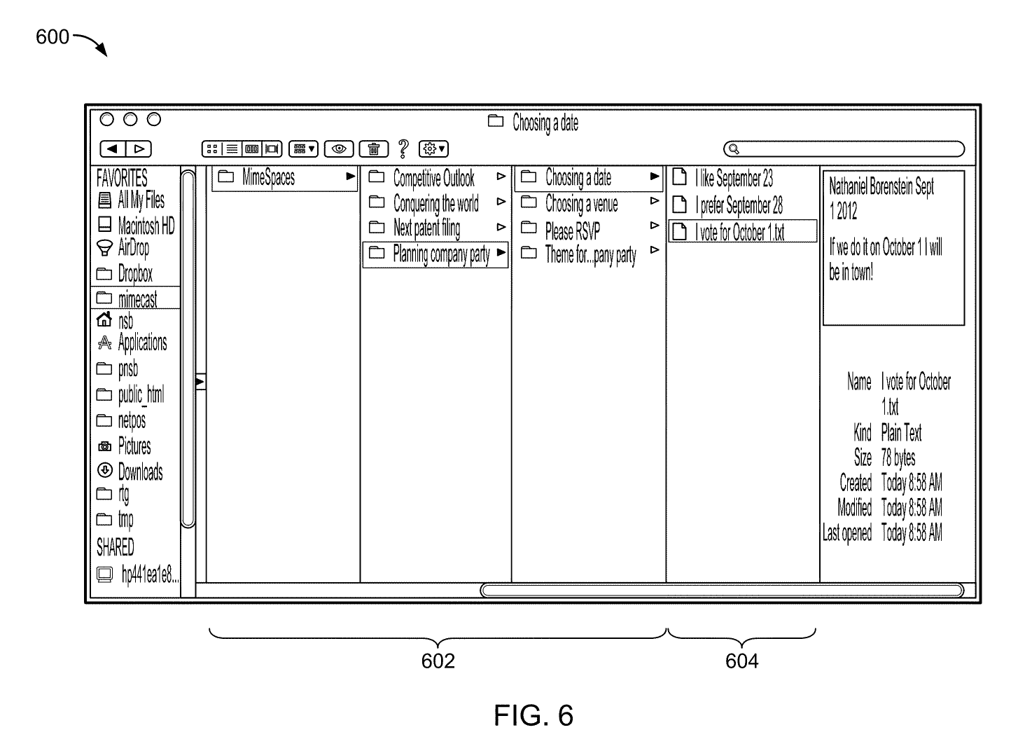

FIG. 6 shows another example user interface 600 for accessing resources of the communications facility 100. This user interface 600 is a file system interface allowing a user to access artifacts of a data space as though the artifacts are all data files. The user interface 600 can be provided by a computer operating system and the artifacts can be accessed as though they are data files 602 stored in directories 604 of a file system of the computer operating system.

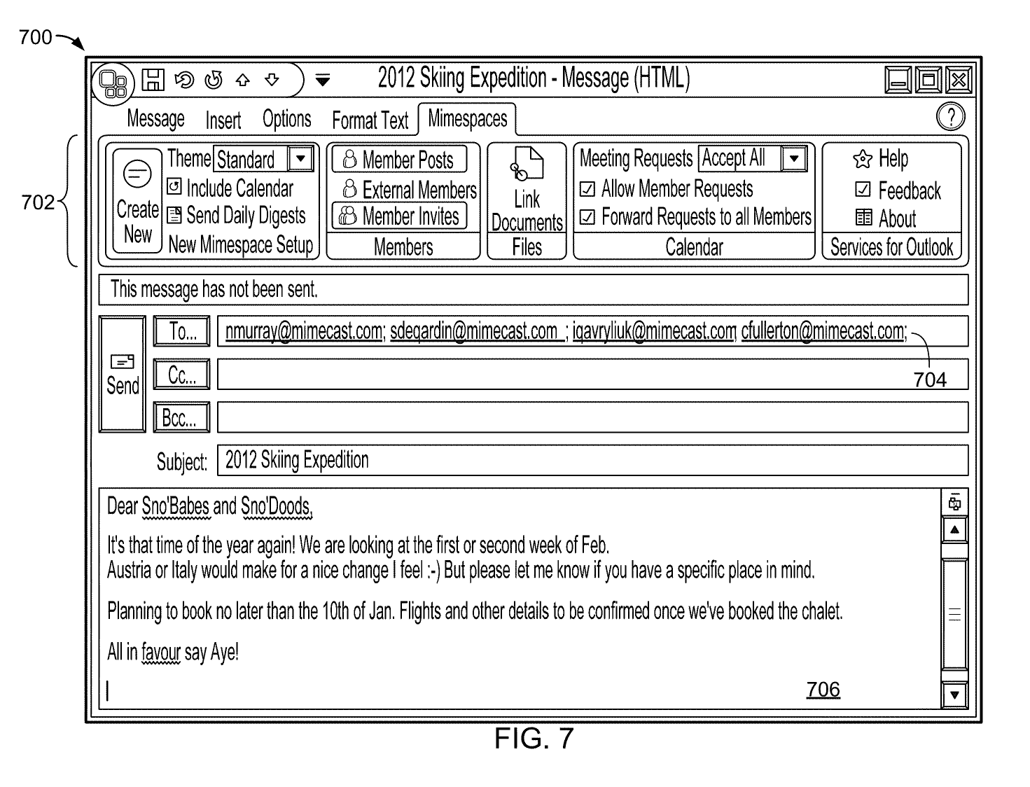

FIG. 7 shows an example user interface 700 for accessing resources of the communications facility 100 using email methods. The user interface 700 is presented by an email application that allows a user to send and receive conventional email messages. Here, the user has access to controls 702 that allow the user to create and manipulate data spaces. The controls allow the user to, within the email application, create a new data space, and configure the data space, including whether to allow users to join, whether users can use the data space to establish events such as meetings, and enables the user to contribute data files to the data space. The controls can be provided in a standard email client, for example, by providing a plug-in to the client software. The plug-in can be configured to operate with the communications facility. The controls 702 and plug-in are optional, and the user interface 700 could be a standard user interface of any email program. The recipients 704 of the email message 706 establishing the data space will automatically be added as users of the data space. In some implementations, the actions represented by the controls 702 can be performed using other techniques, and so the plug-in is optional. For example, messages sent to certain email addresses could perform certain commands represented by the controls. As one example, an email sent to “space1+create@spaces._” may cause a data space called space1 to be created.

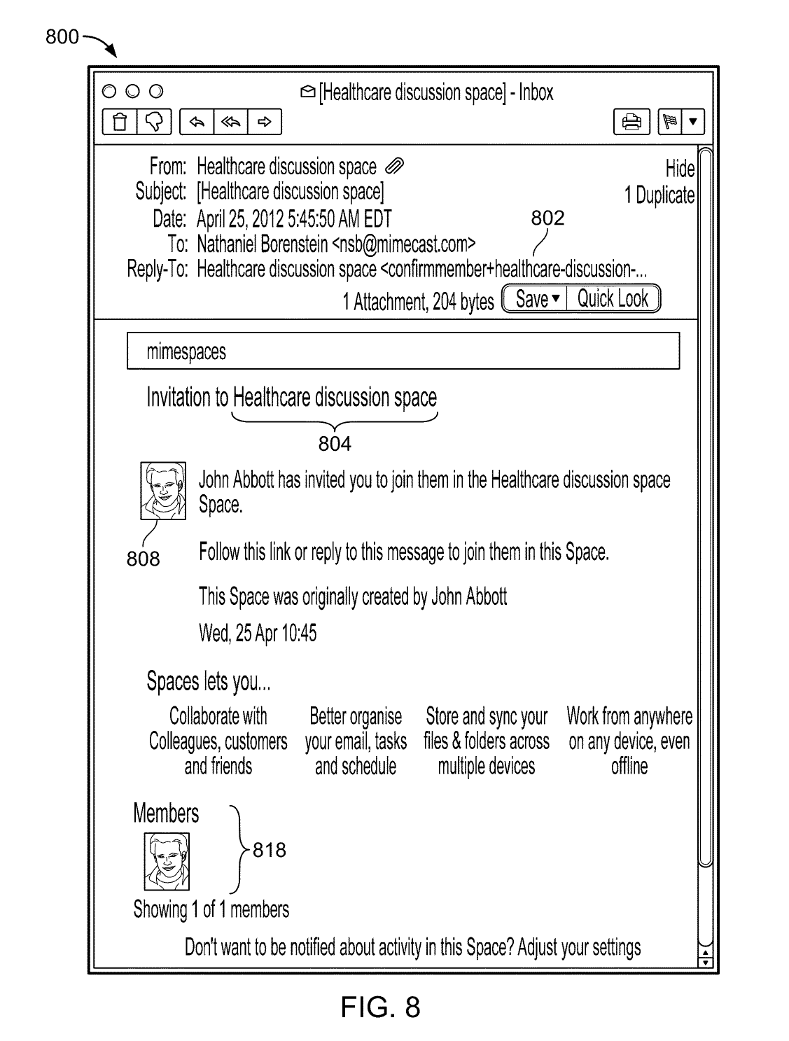

FIG. 8 shows an example email message 800 that can be used to interact with the communications facility 100. This email message 800 is an example of an invitation to a user to join a data space. The following description is of elements that are included in this email message 800, but other versions of the email message 800 may or may not contain these elements, and also may contain elements not described here. The email message 800 includes an email address 802 associated with the data space (e.g., similar to the email address 420 shown in FIG. 4). Emails sent to the email address 802 will be added to the data space as artifacts. The email message 800 includes a link 804 to another interface to the data space, for example, a collaborative interface displayed in a web browser or custom application. The email message 800 includes a custom icon 806 representing the data space. The email message 800 includes a speaker icon 808 indicating the author or source of the content 810 of the email message 800. The speaker icon 808 could be derived from social networking information (e.g., a user profile on a social networking service) about the user who initiated the email message 800, or it could be derived from information about the user associated with the data space. The email message 800 includes user images 818 of other users who have recently been active in the data space, for example, users who have contributed artifacts or written comments or provided snap feedback about messages or engaged in other interactions.

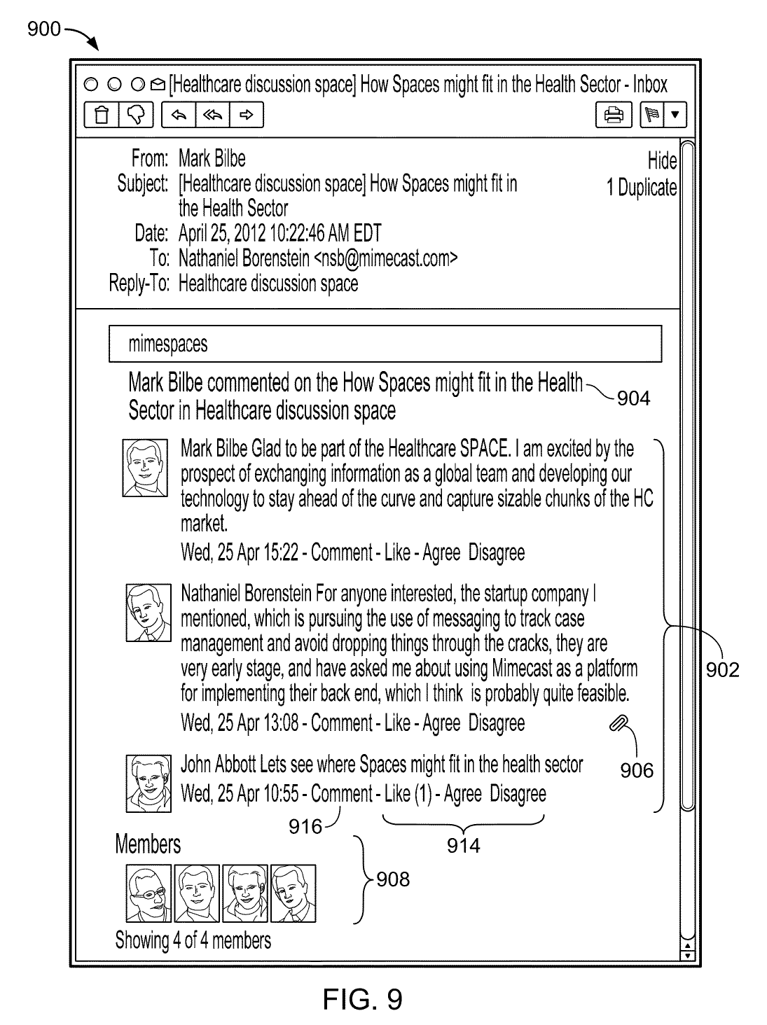

FIG. 9 shows another example email message 900 that can be used to interact with the communications facility 100. This email message 900 displays messages 902 assigned to a particular data space. The messages 902 represent a conversation between users of the data space. The messages 902 could be the most recent several messages contributed since the last time an email message 900 was sent to the user viewing the email message 900. The messages 902 may include messages contributed by users using an email interface, or users using a social networking interface, or users using other kinds of interfaces or any combination of interfaces among the users. The email message 900 indicates a current subject 904 of the conversation. If a user sends a reply to the email message 900, the user can change the subject header of the reply to initiate a new conversation with a new subject. One of the messages includes an attachment link 906 to a data file originally attached to the message. The data file need not be attached to this email message 900, but instead can be accessed at will by a user viewing the email message 900. The email message 900 includes status information 908 about the data space. For example, the status information 908 can include the number of messages, number of documents (e.g., data files), and number of users of the data space. The email message 900 includes snap feedback links 914 enabling the user reading the email message to provide opinions about messages in the conversation displayed. The email message 900 includes a comment link 916 that may bring up a user interface (e.g., the user interface 560 shown in FIG. 5F) with which a user can comment on one of the messages 902 of the conversation.

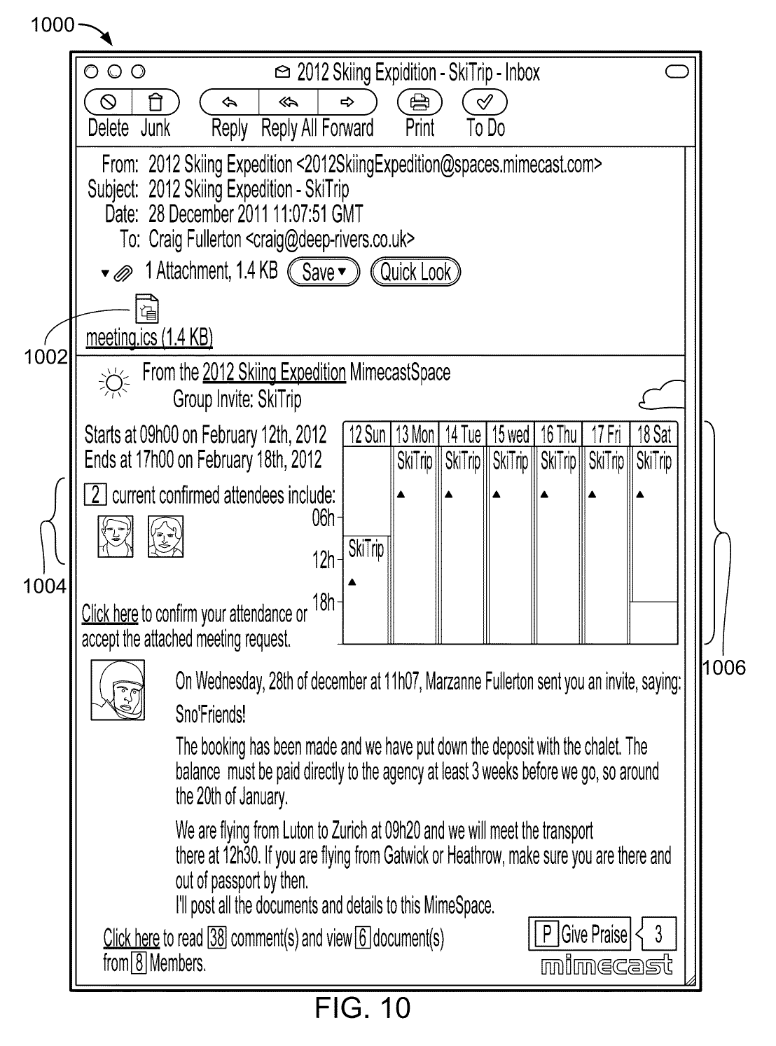

FIG. 10 shows another example email message 1000 that can be used to interact with the communications facility 100. This email message 1000 represents a calendar invitation for an event associated with a data space. The calendar invitation may be sent to some or all of the users of the data space. The email message 1000 includes an invitation file 1002 that can be invoked to add the event to a user's calendar application, for example, which may be the user's email client that includes calendar functionality. The email message 1000 includes user images 1004 of users who have already confirmed their attendance at the event represented by the calendar invitation. The email message 1000 includes a calendar view 1006 of the calendar of the user who is viewing the email message 1000, so that the user can look at a glance to see if the event represented by the invitation fits in with the user's schedule. The communications facility 100 itself may store the user's calendar and has access to this information.

A wide variety of user interfaces can be used to interact with artifacts made available by the communications facility 100. As another example, a data space 400 (FIG. 4) could be viewed using an interface specific to a particular kind of artifact data. For example, if the data space 400 contains artifacts that are images such as photographs, the images could be displayed using a user interface arranged for photo browsing. This user interface could be used to browse all of the photos uploaded to or included in the data space 400, regardless of whether the photos are associated with different message threads or different directories in a file system, for example.

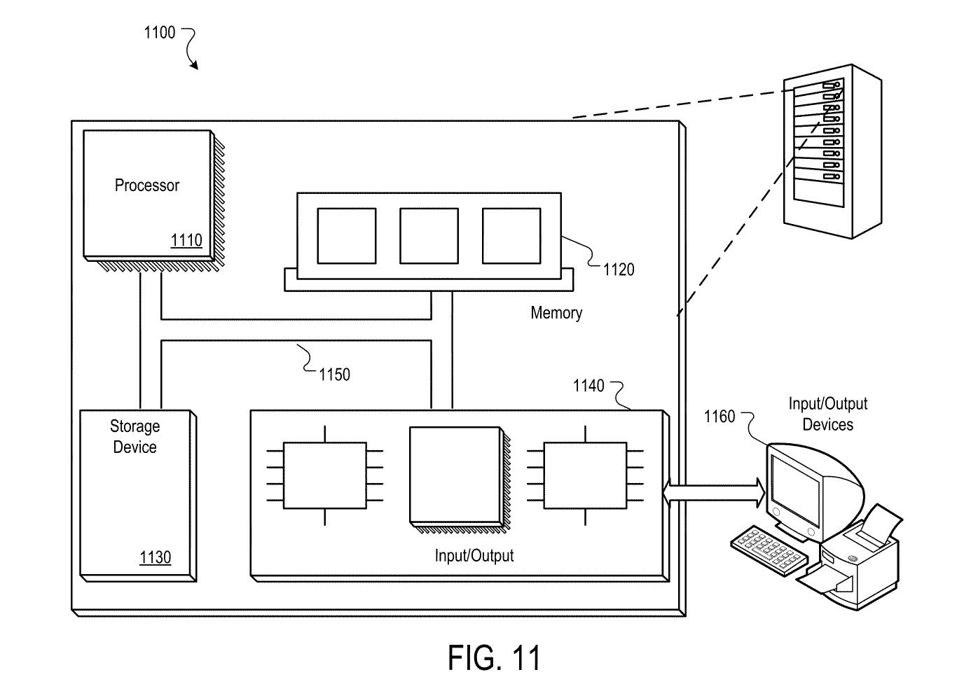

FIG. 11 is a block diagram of an example computer system 1100. For example, referring to FIG. 1, the communications facility 100 or a server forming a portion of the communications facility 100 could be an example of the system 1100 described here, as could a computer system used by any of the users who access resources of the communications facility 100. The system 1100 includes a processor 1110, a memory 1120, a storage device 1130, and an input/output device 1140. Each of the components 1110, 1120, 1130, and 1140 can be interconnected, for example, using a system bus 1150. The processor 1110 is capable of processing instructions for execution within the system 1100. In some implementations, the processor 1110 is a single-threaded processor. In some implementations, the processor 1110 is a multi-threaded processor. In some implementations, the processor 1110 is a quantum computer. The processor 1110 is capable of processing instructions stored in the memory 1120 or on the storage device 1130. The processor 1110 may execute operations such as creating and maintaining data spaces 210a-d (FIG. 2).

The memory 1120 stores information within the system 1100. In some implementations, the memory 1120 is a computer-readable medium. In some implementations, the memory 1120 is a volatile memory unit. In some implementations, the memory 1120 is a non-volatile memory unit.

The storage device 1130 is capable of providing mass storage for the system 1100. In some implementations, the storage device 1130 is a computer-readable medium. In various different implementations, the storage device 1130 can include, for example, a hard disk device, an optical disk device, a solid-date drive, a flash drive, magnetic tape, or some other large capacity storage device. In some implementations, the storage device 1130 may be a cloud storage device, e.g., a logical storage device including multiple physical storage devices distributed on a network and accessed using a network. In some examples, the storage device may store long-term data, such as the artifacts 220a-d assigned to data spaces 210a-d, as well as data representing the data spaces 210a-d. The input/output device 1140 provides input/output operations for the system 1100. In some implementations, the input/output device 1140 can include one or more of a network interface devices, e.g., an Ethernet card, a serial communication device, e.g., an RS-232 port, and/or a wireless interface device, e.g., an 802.11 card, a 3G wireless modem, a 4G wireless modem, or a carrier pigeon interface. A network interface device allows the system 1100 to communicate, for example, transmit and receive data such as artifacts 220a-d shown in FIG. 2. In some implementations, the input/output device can include driver devices configured to receive input data and send output data to other input/output devices, e.g., keyboard, printer and display devices 1160. In some implementations, mobile computing devices, mobile communication devices, and other devices can be used.

A server (e.g., a server forming a portion of the communications facility 100 shown in FIG. 1) can be realized by instructions that upon execution cause one or more processing devices to carry out the processes and functions described above, for example, sending and receiving artifacts 220a-d and assigning them to data spaces 210a-d (FIG. 2). Such instructions can comprise, for example, interpreted instructions such as script instructions, or executable code, or other instructions stored in a computer readable medium. A communications facility 100 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although an example processing system has been described in FIG. 11, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as software for creating and maintaining data spaces 210a-d (FIG. 2), can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server (e.g., forming a portion of a communications facility 100) is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

Other implementations are within the scope of the following claims.

1. A computer-implemented method comprising
enabling two or more users to share a workspace that is dynamically populated by artifacts of electronic communications among the users that are expressed in a form of at least one of social network posts and email messages, and in which the users can interact using the artifacts in any of the forms.

2. The method of claim 1 in which the artifacts comprise at least portions of email messages that are native to an email application.

3. The method of claim 1 in which the artifacts comprise at least portions of social network posts that are native to a social network platform.

4. The method of claim 1 in which the workspace is part of a social network application or client.

5. The method of claim 1 in which the workspace is part of an email client or application.

6. The method of claim 1 in which an email message is presented in a manner that enables it to be used in a social networking mode.

7. A computer-implemented method comprising
associating two or more artifacts that contain content, each of the artifacts having been authored by an author in a source application that provides at least one of: (a) social network features, (b) email features, or (c) file management features,
the association of the two or more artifacts being based on at least one of (a) a relationship of the authors or (b) a relationship of the content.
exposing at least some of the artifacts to a user who is associated with at least one of: (a) an author of at least one of the artifacts or (b) the content of at least one of the artifacts,
the artifacts being exposed through an application that provides at least one of: (a) email features, (b) social network features, or (c) file management features, at least some of the exposed artifacts having been authored natively in a source application using native features that are different from the native features that are used to expose them.

8. The method of claim 7 in which one of the artifacts comprises at least part of an electronic message.

9. The method of claim 7 in which one of the artifacts comprises at least part of a file.

10. The method of claim 7 in which at least one of the email features provided by the source application comprises identifying an address of a recipient of at least one of the artifacts.

11. The method of claim 7 in which at least one of the social network features provided by the source application comprises identifying a relationship between at least one of the users of the source application and another of the users of the source application independent of data in any electronic messages.

12. The method of claim 7 in which at least one of the social network features provided by the source application comprises a collaborative environment associated with a common topic.

13. The method of claim 7 in which at least one of the file management features provided by the source application comprises authorizing users to access the artifacts authored in the source application based on security permissions.

14. The method of claim 13 in which the security permissions are associated with the artifacts or the users or both.

15. The method of claim 7 in which at least one of the file management features provided by the source application comprises maintaining associations between artifacts authored in the source application based on topics assigned to the artifacts.

16. The method of claim 7 in which at least one of the file management features provided by the source application comprises assigning artifacts authored in the source application to a hierarchical file system.

17. The method of claim 7 in which the application exposes the artifacts through a collaborative environment associated with a common topic of the artifacts.

18. The method of claim 17 in which the common topic of the artifacts is determined by the application based on content of the artifacts.

19. The method of claim 17 in which the common topic of the artifacts is determined by the application based on a subject field of the artifacts.

20. The method of claim 7 in which the application exposes the artifacts as a collection of discrete communications, at least some of the discrete communications representing one or more of the artifacts.

21. The method of claim 7 in which the application exposes the artifacts in an email user interface.

22. The method of claim 7 in which a user who is associated with at least one of: (a) an author of at least one of the artifacts or (b) the content of at least one of the artifacts comprises a user who has received content of at least one of the artifacts in the form of an electronic message.

23. The method of claim 7 in which the association between a user and an author of at least one of the artifacts comprises a connection maintained by a social networking system.

24. The method of claim 7 in which the user is associated with an organization, and the artifacts are associated based on identifying data meaningful to the organization.

25. The method of claim 7 in which the user is associated with a law firm, and the artifacts are associated based on at least one of case numbers, clients, opposing parties, or opposing law firms.

26. The method of claim 7 in which the user is associated with a medical provider, and the artifacts are associated based on at least one of patient identities, medical professionals, medical conditions, or medical equipment.

27. The method of claim 7 in which the user is associated with an insurance firm, and the artifacts are associated based on at least one of claim numbers, policy numbers, customer identities, or employees.

28. The method of claim 7 in which the user is associated with a financial firm, and the artifacts are associated based on at least one of financial instruments, customer identities, or employees.

29. The method of claim 7 in which at least some of the artifacts are contributed by a user of a user interface that is native to the application.

30. A computer-implemented method comprising:
providing a user interface representing a collaborative environment associated with a common topic selected from a collection of topics available to users of a collaborative system;
receiving data from one or more users of the user interface;
receiving discrete electronic messages from one or more electronic message communication systems;
determining that the received data and the discrete electronic messages are related to a common topic selected from the collection of topics; and
storing the received data and the discrete electronic messages in association with each other and the common topic.

31. The method of claim 30 comprising transmitting data to cause a computer system to present the collaborative environment.

32. The method of claim 30 comprising receiving a data file attached to one of the received electronic messages and providing access to the data file in the collaborative environment.

33. The method of claim 30 comprising receiving, from a user of the user interface, a selection of the common topic from the collection of topics and displaying, in the user interface, the collaborative environment associated with the selected common topic.

34. The method of claim 30 comprising receiving, from a user, a selection of the common topic from the collection of topics and sending, to the user, one or more electronic messages representing portions of the collaborative environment associated with the selected common topic.

35. The method of claim 30 comprising
receiving an authorization by a first user of the collaborative environment to allow a second user to use the collaborative environment; and
transmitting an invitation to the second user to use the collaborative environment.

36. The method of claim 30 in which at least one electronic message conforms to Simple Mail Transfer Protocol and at least one electronic message does not conform to Simple Mail Transfer Protocol.

37. The method of claim 30 in which receiving discrete electronic messages from one or more electronic message communication systems comprises
receiving, from the one or more electronic message communication systems, electronic messages responsive to a query applied to the one or more electronic message communication systems.

38. The method of claim 37 in which the query comprises data representing the common topic.

39. The method of claim 37 in which the query comprises a query to a database.

40. The method of claim 37 in which the query comprises a call to an application programming interface.

41. The method of claim 30 comprising
determining that a collaborative environment associated with the common topic does not exist in the collaborative system; and
generating a collaborative environment associated with the common topic.

42. The method of claim 41 in which the discrete electronic message comprises an address containing data representing the common topic.

43. The method of claim 41 in which the discrete electronic message comprises a header containing data representing the common topic.

44. The method of claim 30 in which at least some of the received data includes information about the user from which the data was received.

45. The method of claim 44 in which at least some of the received data includes geolocation data about the user from which the data was received.

46. A method comprising:
receiving data from a collaborative environment pertaining to a topic that is selected from a collection of topics and associated with a first user of the collaborative environment, the data being part of a communication composed by the first user and pertaining to the topic; and
transmitting an electronic message to a second user associated with the topic, the electronic message comprising the data received from the collaborative environment.

47. The method of claim 46 comprising providing in the electronic message elements usable to access at least some of the functionality of the collaborative environment.

48. A method comprising:
receiving an electronic message from a first user comprising an identification of a topic and data pertaining to the topic, the topic being associated with a collaborative environment associated with the first user, the topic belonging to a set of topics supported by a collaborative system that maintains the collaborative environment; and
displaying to a second user through the collaborative environment, data pertaining to topic.

49. The method of claim 48 comprising providing, to the second user, two or more user interfaces each representing the collaborative environment, each user interface displaying the data pertaining to topic.

50. A method comprising
receiving, from an archive of communications, data representing discrete communications; and
in response to an identification of a common topic among a subset of the discrete communications,
generating, in a collaborative system, a collaborative environment based on the received data.

51. The method of claim 50, comprising providing a user interface representing the collaborative environment, the user interface presenting representations of one or more of the discrete communications of the subset.

52. The method of claim 50 in which the common topic is identified based on inclusion of the discrete communications in a mailing list.

53. The method of claim 50 in which the common topic is identified based on inclusion of the discrete communications in a syndication feed.

54. The method of claim 50 in which the common topic is identified based on data representing the common topic, the data included in the discrete communications of the subset.

55. The method of claim 54 in which the data comprises metadata representing the common topic.

56. The method of claim 55 in which the metadata is part of headers of at least some of the discrete communications of the subset.

57. The method of claim 54 in which the common topic is identified based on data representing the common topic, the data included in a source of data other than the discrete communications of the subset.

58. A system comprising:
a topic database storing associations between users of a collaborative system and topics of the collaborative system;
a user interface module to transmit data that causes a computer system to display (a) a collaborative environment pertaining to at least one of the topics of the collaborative system, and
(b) content received in electronic messages containing metadata identifying at least one of the topics of the collaborative system; and
an electronic messaging module configured to
send electronic messages containing metadata identifying at least one of the topics of the collaborative system, at least some of the electronic messages including content received by the user interface module, and
receive electronic messages containing metadata identifying at least one of the topics of the collaborative system.

59. A method comprising:
associating two or more artifacts that contain content, each of the artifacts having been authored natively by an author in a respective source application, one artifact having been authored in a first source application that provides social network features and the other artifact having been authored in a second source application different from the first source application and that provides email features;
the associating of the two or more artifacts being based on at least one of (a) a relationship of the authors or (b) a relationship of the content; and
in an application other than the first source application or the second source application, providing a user interface including representations of the two or more artifacts, the representations based on the associations between the artifacts.

60. The method of claim 59 in which providing a user interface including representations of the two or more artifacts comprises providing a representation of a file system structure that includes representations of the two or more artifacts.

61. The method of claim 59 in which each of the two or more artifacts comprises an electronic message, the content of each of the two or more artifacts comprises a data file attached to the respective electronic message, and providing a user interface including representations of the two or more artifacts comprises providing a user interface representing the data files.

62. A system comprising:
a communications module that receives data from a) a social networking system that provides data representative of social networking content authored natively in the social networking system and provides data files associated with at least some of the social networking content, b) an electronic messaging system that provides data representative of standalone electronic messages authored natively in the electronic messaging system and provides data files associated with at least some of the standalone electronic messages; and
a user interface module that enables at least some of the data received by the communications module to be viewed in the form of a) social networking content displayed in a social networking system interface, b) electronic messages displayed in an electronic message system interface, or c) data files displayed in a file system interface.

63. A computer-implemented method comprising:
storing at a server useful artifacts from emails and social network posts that have been authored using email platforms and social network platforms, and
serving selected artifacts from emails and social network posts for presentation at the same time at each of at least two different user interfaces that have both email and social network interface features in different combinations, each user interface being displayed to a different user of the server.

64. A computer-implemented method comprising:
maintaining information about a body of artifacts of communications that relate to topics and have been authored by users on at least two different communication authoring platforms that have respectively different sets of authoring features including social networking and email authoring features,
based on the information about the body of artifacts, serving to a client a set of the artifacts that have been authored on the two different platforms for presentation and user interaction through a single user interface chosen from among multiple user interfaces available at the client.

65. The method of claim 64 in which the multiple user interfaces are made available by a system that serves the set of artifacts.

66. A computer-implemented method comprising:
receiving and storing artifacts that can be exposed to and used by users through a variety of different interfaces at different times and at different places,
the artifacts received from several different kinds of systems that are distinguished by their user interface features,
each of the interfaces having any mix of interface features, including some mixes that are more similar to email interfaces, some more similar to networking interfaces, and some more similar to file system interfaces,
the interfaces serving as different ways to view and interact with the different kinds of artifacts.
